(19) United States
(12) Patent Application Publication
(10) Pub. No.: US 2026/0290296 A1
(43) Pub. Date: Sep. 24, 2026

(54) AI-BASED SELF-ADAPTIVE RHYTHM ELECTRONIC PIANO ACCOMPANIMENT SYSTEM

(71) Applicant: Bihong Chen, Shenzhen City (CN)

(72) Inventor: Bihong Chen, Shenzhen City (CN)

(21) Appl. No.: 19/569,411

(22) Filed: Mar. 17, 2026

(30) Foreign Application Priority Data
Mar. 19, 2025 (CN) 202510327526.9

(51) Int. Cl. G10H 1/42

(52) U.S. Cl. CPC G10H 1/42; G10H 2210/005; G10H 2210/066; G10H 2210/265; G10H 2210/325; G10H 2220/101

(57) ABSTRACT

An AI-based self-adaptive rhythm electronic piano accompaniment system, comprising a single-key trigger module: configured to indicate the progression of accompaniment during performance; a velocity-to-control signal conversion module: configured to convert velocity signals acquired from sensing sensors into music control signals; an AI-based accompaniment generation module: configured to adjust the accompaniment rhythm based on trigger signals and playing velocity, and generate real-time accompaniment or harmonies. The system further comprises: a pitch calculation unit: configured to calculate accompaniment pitch; a timbre parameter adjustment module for adjusting parameters for timbre generation; a timbre generation module for synthesizing timbre data; a dynamic pitch range adjustment module for dynamically adjusting the output pitch range based on triggered notes; an audio output module for converting timbre data into sound and outputting it; a control unit for receiving user instructions and adjusting system configuration parameters.

### TECHNICAL FIELD

The invention relates to the technical field of music, and in particular to an artificial intelligence based (AI-based) self-adaptive rhythm electronic piano accompaniment system.

### BACKGROUND ART

In modern music performances, accompaniment is an important factor in improving the singing effect. The traditional accompaniment method usually relies on a pre-recorded accompaniment tape, and the singer needs to sing according to the rhythm and speed of the accompaniment tape. This method has the following main problems.

The singer must strictly follow the rhythm and speed of the accompaniment tape and cannot freely adjust according to his own emotional expression and the atmosphere of the scene. At the same time, in order to keep in sync with the accompaniment tape, the singer needs to master certain techniques, such as staring at the lyrics subtitles on the screen to ensure that they do not deviate from the rhythm, and piano playing requires long-term practice and professional training, which is an insurmountable obstacle for most amateur singers.

### SUMMARY OF THE INVENTION

The technical problem to be solved by the invention is to overcome the defects of the above technology and provide an AI-based self-adaptive rhythm electronic piano accompaniment system.

In order to solve the above technical problems, the invention provides an AI-based self-adaptive rhythm electronic piano accompaniment system, comprising:
a control unit: configured to receive and process information from all modules, and transmit processed results to relevant modules for further processing;
a single-key trigger module: provided with a trigger key for users to activate accompaniment during performance; a sensing sensor unit is provided below the key to detect the force applied when the key is pressed;
a velocity-control signal conversion module: configured to receive and process signals from the sensing sensor and convert them into corresponding music control signals;
a storage module: configured to store accompaniment note sequence data of songs, as well as timbre parameter data, preset resonance parameters, parameters of velocity-control signal mapping formulas, and parameters of a timbre synthesis model;
an AI-based accompaniment generation module: configured to retrieve accompaniment note sequence data of corresponding songs from the storage module based on the triggered single key and its timing sequence, and generate real-time accompaniment or harmonies;
a pitch calculation unit: configured to calculate accompaniment pitch based on note numbers and accidentals in the accompaniment note sequence;
a timbre parameter adjustment module: configured to adjust parameters required for timbre generation based on the accompaniment note sequence output by the AI-based accompaniment generation module, the pitch calculated by the pitch calculation unit, and the velocity signal;
a timbre generation module: configured to calculate and synthesize timbre data according to parameters output by the timbre parameter adjustment module;
a dynamic pitch range adjustment module: capable of dynamically adjusting the pitch range output of the timbre generation module based on the triggered note range;
an audio output module: configured to convert the timbre data into sound and output it.

The advantages of the invention compared with the prior art are:
1. through the setting of a single trigger key in the single-key trigger module, the performer only needs to play this key to complete the accompaniment, which greatly simplifies the performance process and reduces the technical requirements for the performer, which allows even ordinary users without piano basics to easily get started and enjoy the fun of playing and singing by themselves;
2. the song selection menu, system status information and the accompaniment note sequence of the currently played song are displayed through the interactive interface unit; at the same time, users can adjust and select parameters through touch operations, making the system more intuitive and easy to use.

### BRIEF DESCRIPTION OF THE DRAWINGS

FIG. 1 is a schematic structural diagram of AI-based self-adaptive rhythm electronic piano accompaniment system according to the invention.

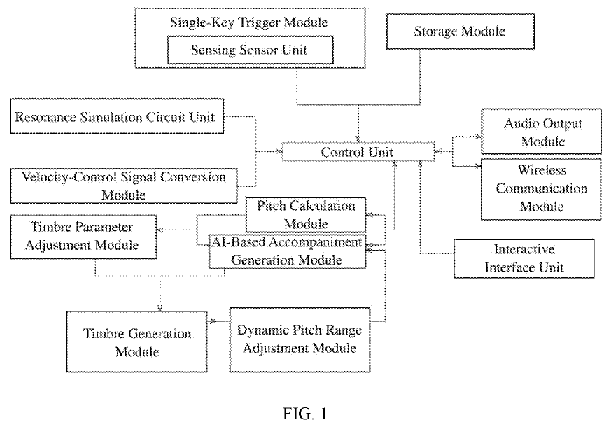

### SPECIFIC EMBODIMENT OF THE INVENTION

In order to make the purpose, technical solution and advantages of the embodiments of the invention more clear, the technical solution in the embodiments of the invention will be clearly and completely described hereinafter with reference to the drawings in the embodiments of the invention.

As shown in the FIGURE, an AI-based self-adaptive rhythm electronic piano accompaniment system, comprising:
a control unit: configured to receive and process information from all modules, and transmit processed results to relevant modules for further processing;
a single-key trigger module: provided with a trigger key for users to activate accompaniment during performance; a sensing sensor unit is provided below the key to detect the force applied when the key is pressed;
a velocity-control signal conversion module: configured to receive and process signals from the sensing sensor and convert them into corresponding music control signals;
a storage module: configured to store accompaniment note sequence data of songs, as well as timbre parameter data, preset resonance parameters, parameters of velocity-control signal mapping formulas, and parameters of a timbre synthesis model;
an AI-based accompaniment generation module: configured to retrieve accompaniment note sequence data of corresponding songs from the storage module based on the triggered single key and its timing sequence, and generate real-time accompaniment or harmonies;
a pitch calculation unit: configured to calculate accompaniment pitch based on note numbers and accidentals in the accompaniment note sequence;
a timbre parameter adjustment module: configured to adjust parameters required for timbre generation based on the accompaniment note sequence output by the AI-based accompaniment generation module, the pitch calculated by the pitch calculation unit, and the velocity signal;
a timbre generation module: configured to calculate and synthesize timbre data according to parameters output by the timbre parameter adjustment module;
a dynamic pitch range adjustment module: capable of dynamically adjusting the pitch range output of the timbre generation module based on the triggered note range;
an audio output module: configured to convert the timbre data into sound and output it.

It further comprises a resonance simulation circuit unit, which is configured to apply resonance effect processing to the generated timbre data based on preset resonance parameters.

It further comprises an interactive interface unit, which is configured to display a song selection menu, system status information, and the currently played song accompaniment note sequence.

It further comprises a wireless communication module, which is configured to establish wireless connections with smart devices.

The invention and the embodiments thereof are described hereinabove, and this description is not restrictive. What is shown in the drawings is only one of the embodiments of the invention, and the actual structure is not limited thereto. All in all, structural methods and embodiments similar to the technical solution without deviating from the purpose of the invention made by those of ordinary skill in the art without creative design shall all fall within the protection scope of the invention.

1. An artificial intelligence based (AI-based) self-adaptive rhythm electronic piano accompaniment system, comprising:
a control unit: configured to receive and process information from all modules, and transmit processed results to relevant modules for further processing;
a single-key trigger module: provided with a trigger key for users to activate accompaniment during performance; a sensing sensor unit is provided below the key to detect the force applied when the key is pressed;
a velocity-control signal conversion module: configured to receive and process signals from the sensing sensor and convert them into corresponding music control signals;
a storage module: configured to store accompaniment note sequence data of songs, as well as timbre parameter data, preset resonance parameters, parameters of velocity-control signal mapping formulas, and parameters of a timbre synthesis model;
an AI-based accompaniment generation module: configured to retrieve accompaniment note sequence data of corresponding songs from the storage module based on the triggered single key and its timing sequence, and generate real-time accompaniment or harmonies;
a pitch calculation unit: configured to calculate accompaniment pitch based on note numbers and accidentals in the accompaniment note sequence;
a timbre parameter adjustment module: configured to adjust parameters required for timbre generation based on the accompaniment note sequence output by the AI-based accompaniment generation module, the pitch calculated by the pitch calculation unit, and the velocity signal;
a timbre generation module: configured to calculate and synthesize timbre data according to parameters output by the timbre parameter adjustment module;
a dynamic pitch range adjustment module: capable of dynamically adjusting the pitch range output of the timbre generation module based on the triggered note range;
an audio output module: configured to convert the timbre data into sound and output it.

2. The AI-based self-adaptive rhythm electronic piano accompaniment system of claim 1, wherein it further comprises a resonance simulation circuit unit, which is configured to apply resonance effect processing to the generated timbre data based on preset resonance parameters.

3. The AI-based self-adaptive rhythm electronic piano accompaniment system of claim 1, wherein it further comprises an interactive interface unit, which is configured to display a song selection menu, system status information, and the currently played song accompaniment note sequence.

4. The AI-based self-adaptive rhythm electronic piano accompaniment system of claim 1, wherein it further comprises a wireless communication module, which is configured to establish wireless connections with smart devices.
